(19) United States
(12) Patent Application Publication
(10) Pub. No.: US 2024/0403623 A1
(43) Pub. Date: Dec. 5, 2024

(54) GENERATIVE ARTIFICIAL INTELLIGENCE FOR EMBEDDINGS USED AS INPUTS TO MACHINE LEARNING MODELS

(71) Applicant: Microsoft Technology Licensing LLC, Redmond, WA (US)

(72) Inventors: Rafikah Binte Mohamed Halim, New York, NY (US); Vinay Praneeth Boda, San Jose, CA (US); Sirou Zhu, Sunnyvale, CA (US)

(21) Appl. No.: 18/213,061

(22) Filed: Jun. 22, 2023

Related U.S. Application Data
(60) Provisional application No. 63/470,591, filed on Jun. 2, 2023.
(60) Provisional application No. 63/469,703, filed on May 30, 2023.

(51) Int. Cl. G06N 3/08

(52) U.S. Cl. CPC G06N 3/08

(57) ABSTRACT

In an example embodiment, a generative artificial intelligence (GAI) model is used to generate embeddings, eliminating the need for a separately trained embedding model or layer. These embeddings may then be used as input to another machine learning model. In some example embodiments, these embeddings are generated on interaction data regarding one or more interactions between a user and digital content presented on one or more online platforms.

### CROSS-REFERENCE TO RELATED APPLICATIONS

This application claims priority to U.S. Provisional Application No. 63/470,591, filed Jun. 2, 2023, entitled “GENERATIVE ARTIFICIAL INTELLIGENCE FOR EMBEDDINGS USED AS INPUTS TO MACHINE LEARNING MODELS,” and U.S. Provisional Application No. 63/469,703, filed May 30, 2023, entitled “ARTIFICIAL INTELLIGENCE RECOMMENDATIONS FOR MATCHING CONTENT OF ONE CONTENT TYPE WITH CONTENT OF ANOTHER,” both of which are incorporated herein by reference in their entirety.

### TECHNICAL FIELD

The present disclosure generally relates to technical problems encountered in machine learning. More specifically, the present disclosure relates to the use of generative artificial intelligence for the labelling of training data of machine learning models.

### BACKGROUND

The rise of the Internet has occasioned two disparate yet related phenomena: the increase in the presence of online networks, such as social networking services, with their corresponding user profiles and posts visible to large numbers of people; and the increase in the use of such online networks for various forms of communications.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a diagram illustrating a buyer relevance journey map in accordance with an example embodiment.

FIG. 4 is a block diagram illustrating an approach to understanding user experience generally, and not limited to one particular type of content, in accordance with an example embodiment.

FIG. 5 is a flow diagram illustrating a method of determining which pieces of content do display to a user, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

### Description

In various types of computer systems, machine learning algorithms are used to train and utilize machine learning models to perform various tasks. Often these machine learned models are trained to output calculations or scores based on a number of input features, with the importance of the input features being weighted based on coefficients learned during the training process. Often these scores are used as predictions of some sort of human behavior, such as likelihood to be a good fit for a particular job, likelihood that a user will select a particular search result, likelihood that a user will default on a loan, and likelihood that a user will be admitted to a particular school.

In some machine learning models, one or more of these input features are themselves embeddings. An embedding is a representation of a value of a feature in a dimensional space, which allows the machine learning model to perform distance-related measurements when comparing two values of features. Essentially the process of embedding involves learning how to convert discrete symbols, such as words, into continuous representations in a dimensional space. For example, a sequence of user profile data (e.g., location, school, skills) can be embedded into a single vector. In this context, vector refers to the computer science version of the term, in other words an array of values, as opposed to the mathematical version of the term (meaning a line with a direction). The vector of values can represent coordinates in an n-dimensional space (with n being the number of values in the vector).

Embeddings are typically created using their own machine learning models, or at least specialized layers within other machine learning models. These embedding models/layers therefore rely on extensive training of their own, on top of the training needed for the machine learning model in which the embeddings will be fed as input.

In an example embodiment, a generative artificial intelligence (GAI) model is used to generate embeddings, eliminating the need for a separately trained embedding model or layer.

Generative Artificial Intelligence refers to a class of artificial intelligence techniques that involves training models to generate new, original data rather than simply making predictions based on existing data. These models learn the underlying patterns and structures in a given dataset and can generate new samples that are similar to the original data.

Some common examples of generative AI models include Generative Adversarial Networks (GANs), Variational Autoencoders (VAEs), and autoregressive models. These models have been used in a variety of applications such as image and speech synthesis, music composition, and the creation of virtual environments and characters.

When a GAI model generates new, original data, it goes through the process of evaluating and classifying the data input to it. In an example embodiment, the product of this evaluation and classification is utilized to generate embeddings for data, rather than using the output of the generative AI model directly. Thus, for example, passing a user profile from an online network to a GAI model might ordinarily result in the GAI model creating a new, original user profile that is similar to the user profile passed to it. In an example embodiment, however, the new, original user profile is either not generated, or simply discarded. Rather, an embedding for the user profile is generated based on the intermediate work product of the GAI model that it would produce when going through the motions of generating the new, original user profile.

More particularly, the GAI model is used to generate content understanding in the form of the embeddings, rather than (or in addition to) generating content itself.

In an example embodiment, the content understanding/embeddings generated pertain to content being considered for display in an online network, such as a social networking service. This content may be, for example, content being considered for display in a feed portion of the online network. The feed portion is an area of a graphical user interface where updates about users connected to a first user can be presented to the first user, along with other types of contents such as news articles or announcements. In these example embodiments, each piece of content being considered for display in the feed can be submitted to the GAI model to generate the content understanding/embedding for that piece of content, and the separately trained machine learning model, such as a machine learning model trained to determine a likelihood that a user will interact with a piece of content displayed in their feed, is then used to score the likelihood based on that generated content understanding/embedding from the GAI.

In another example embodiment, the embeddings are used for user sentiment understanding. Sentiment refers to how the user feels towards a particular piece of content or topic. Just because a user interacts with or creates a lot of product in a particular topic category does not mean that the user has positive sentiments towards that topic. In some online networks, users are free to provide comments (whether good or bad) on different topics. Thus, in an example embodiment, there may be three categories for sentiments (neutral, positive, negative). User-created content in the form of posts, comments, articles, etc. are accessed, and the GAI model is prompted to categorize each piece of content into one of the three sentiments. The sentiment embeddings can then be used as another signal in the separately trained relevance model.

The result is that the GAI model is capable of generating user embeddings, which identify user sentiment regarding various topics, and also capable of generating content embeddings, which identify the meaning of various pieces of content (including, for example, which topics they content pertain to and how relevant those topics are to the piece of content). With both of these pieces of information, a separate machine learning model can be used to match a user with a piece of content by, for example, ranking a plurality of possible pieces of content to display to a user based on how relevant the piece of content is to the user (which is based on the user's profile embedding and the piece of content embedding from the GAI model).

In an example embodiment, the GAI model is implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer-to-language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a GAN embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game, according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, as we discussed in the previous section, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code.

In either case, the GAI model contains a generative classifier, which can be implemented as, for example, a naïve Bayes classifier. It is the output of this generative classifier that can be leveraged to obtain embeddings, which can then be used as input to a separately trained machine learning model.

The above generally describes the overall process as used during inference-time (when the machine learning model makes the predictions about each piece of content being considered for display in the feed), but the same or similar process of content understanding/embedding can be performed during training as well. Specifically, for some features of the training data used to train the machine learning model, those features are passed into the GAI model to generate an embedding that provides content understanding for those corresponding features. Thus, for example, in the case of a machine learning model used to predict propensity to interact with feed items, the training data may include historical information about past feed items displayed to users, user profile data about those users, and interaction information indicating when those users interacted with the various feed items. From that, for example, the past feed items may be passed one at a time into the GAI model to generate a corresponding embedding, and then the embeddings from the feed items can be used along with the features from the user profile data and interaction information to train the machine learning model using a machine learning algorithm.

This solution is especially useful when the data that is being embedded is content data (in contrast to, for example, user data). The reason is that for data such as user data, there already are robust models to generating content understanding based on, for example, user intent. In other words, machine learning models exist to fairly accurately predict a user's “intent” when encountering a particular graphical user interface (e.g., use it to find a job, use it to find candidate to apply for a job, use it to check up on their connections, etc.). Machine learning models also exist to fairly accurately predict what users would be similar to a given user. What is lacking, however, are machine learning models to accurately predict what a particular piece of content represents. The use of the GAI model to generate content understanding solves this technical problem.

In some example embodiments, the GAI model is used to generate single-dimension embeddings as opposed to multidimensional embeddings. A single-dimension embedding is essentially a single value that represents the content understanding. One specific way that the single-dimension embedding can be represented is as a category. Thus, in these example embodiments, the GAI model generates a category for a particular input piece of content. The categories may either be obtained by the GAI model from a fixed set of categories, or the categories may be supplied to the GAI model when the GAI model is generating the embedding (e.g., at the same time the piece of content is fed into the GAI model to be categorized).

In some example embodiments, the GAI model itself generates its own categories. In this case, the query to the GAI model may be something broad, such as “what is this piece of content about,” which allows the GAI model to generate a free-form description of the piece of content without being restricted to particular categories.

The other advantage to using a GAI model for content understanding of content to be fed to another machine learning model is that the GAI model is robust enough to handle content from different domains. The various pieces of content may be in completely separate types of domains (e.g., one may be textual, another may be a video). Additionally, even when the pieces of content are in similar domains (e.g., they are both textual), their formatting could be completely different (e.g., a news article is generally longer and uses a different writing style than a user posting an update about a job promotion they have received). The GAI model is able to handle content of different domains and actually share some of its understanding across those domains (e.g., feedback it has received about a user post about a recent court decision can influence its understanding about a new article about the court decision, or other court decisions).

The embeddings generated by the GAI model can then be used as input to a separately trained machine learning model. This separately trained machine learning model may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the machine learning algorithm used to train the machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

In an example embodiment, the machine learning model is trained to predict a likelihood for a user to interact with a particular content item. The online network may feed multiple potential content items to display into the model and obtain a prediction score for each. The higher ranked content items (based on the prediction scores) could then be displayed to the user. It should be noted that propensity to interact is merely one goal (or task) the machine learning model may be trained to predict. Multitask optimization machine learning models may be trained to optimize over more than one goal, such as maximizing the likelihood that the user will interact with the piece of content and more broadly maximizing the likelihood that the user will interact with the online network if shown the piece of content.

In other example embodiments, GAI is used for a different purpose than embedding inputs to a separate machine learning model. Specifically, in these example embodiments, GAI is used to generate auxiliary content to be displayed with a piece of content. This auxiliary content explains to the user the relevance or some other information based on the GAI model's understanding of the content. For example, assume a machine learning model determines that a particular product description should be displayed to a user due to a high likelihood that the user will wish to purchase the corresponding product since the user has a particular hobby that is somehow related to the corresponding product. The GAI model may be used to create a short textual description (e.g., “This product is related to hobby A so you may be interested in it”). Alternatively, the GAI model could summarize, for example, a new article in a way that describes its potential usefulness specifically for the individual user as opposed to the more general (and sometimes misleading) headline generated by the news organization. For example, it could say, “This article pertains to the recent court case of X vs. Y, which is relevant to your job as a Z.”

The result is that the system is able to identify a user's phase in their online journey, essentially classifying where the user is in a lifecycle of interactions with an online network. This can then be used as a signal input to a machine learning model that is trained to determine whether to show a particular piece of content to a user. For example, a user may not be interested in purchasing a product right now (i.e., “not in a buying mood”), but that may change later. By identifying that the user is in a phase of the lifecycle where purchasing a product is unlikely, the machine learning model is able to deduce, for example, that it may be more beneficial to delay displaying an ad for a product to the user until the user is in a different phase, even though mathematically there is still some value in displaying the ad now (e.g., there is a small chance the user may be persuaded to purchase the item now even though they are not in a buying mood).

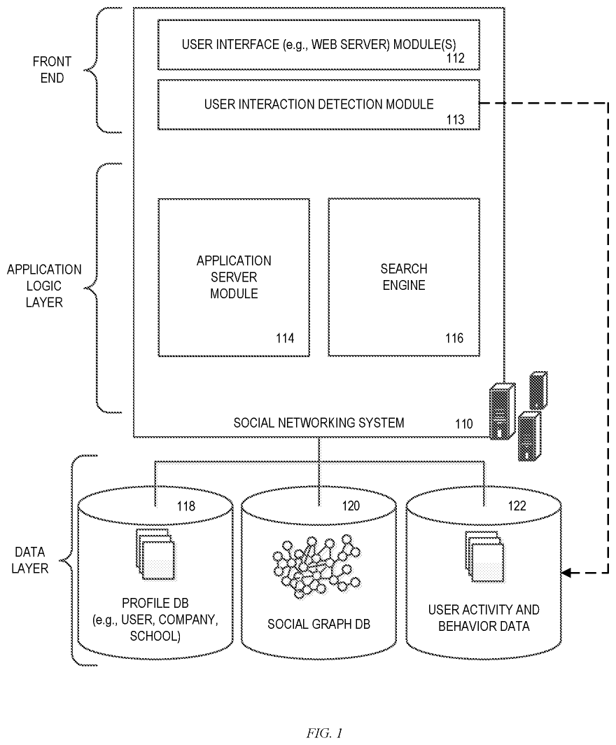

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 1, by the user activity and behavior database 122. This logged activity information may then be used by a search engine 116 to determine search results for a search query.

Additionally, in an example embodiment, the user interaction behavior is used generally to predict general engagement with the social networking service, as opposed to only predicting and optimizing for clicks on specific content. This allows the model to focus more on overall user experience than towards individual clicks (which generally involves modelling towards actions with monetization values). This, for example, allows for models that predict overall engagement with the social networking service, regardless of whether the engagement specifically results in immediate monetization value. This is in contrast to past models that would model specifically towards actions that include immediate monetization value (such as optimizing for number of clicks on sponsored content, while not even trying to optimize for number of clicks on organic content).

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system—specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

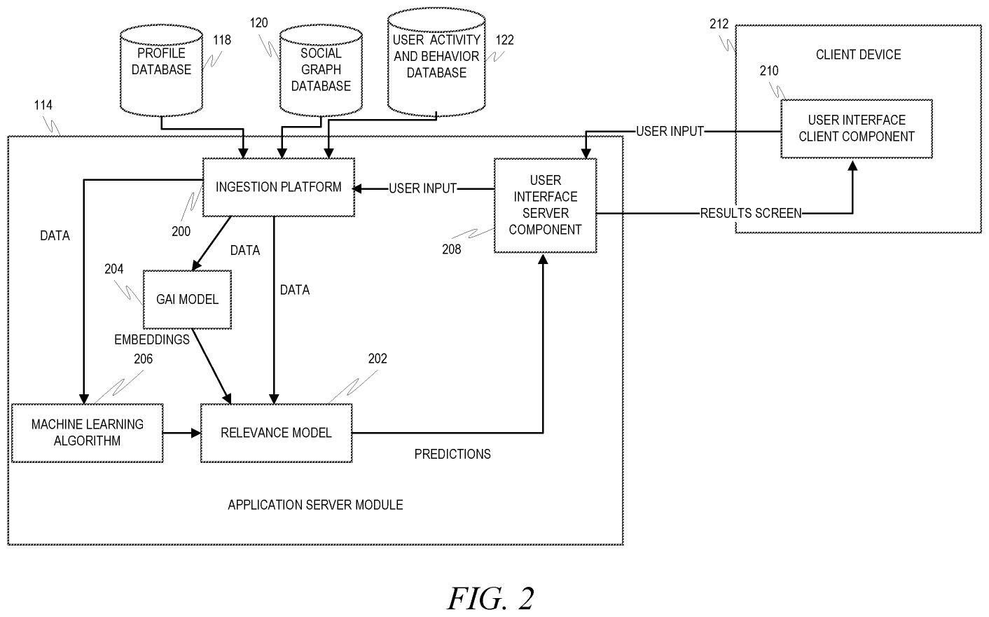

FIG. 2 is a block diagram illustrating the application server module 114 of FIG. 1 in more detail, in accordance with an example embodiment. While in many embodiments the application server module 114 will contain many subcomponents used to perform various actions within the social networking system 110, only those components that are relevant to the present disclosure are depicted in FIG. 2.

Here, an ingestion platform 200 obtains information from the profile database 118, the social graph database 120 and/or the user activity and behavior database 122, as well as obtaining information about content items relevant to a relevance model 202. At training time, this information may represent training data, and thus may be considered to be “sample data”. The ingestion platform 200 sends some of this information to a GAI model 204, which outputs an embedding indicative of the underlying meaning of the content items. This embedding may then be associated with the other training data and all of the training data may be fed to a machine learning algorithm 206 that trains the relevance model 202.

At prediction time, such as when a social networking service needs to determine which content items to present to a particular user and in what order, the ingestion platform 200 sends information corresponding to each considered content item to the GAI model 204 to obtain an embedding of each. Each of these embeddings can then be fed, along with the information about the particular user and potentially other information about the considered content items, to the relevance model 202, which outputs a prediction of the relevance of each content item to the particular user.

In some example embodiments, this information is transmitted in the form of feature vectors. For example, each user profile may have its own feature vector formed of the information in the profile database 118, the social graph database 120, and the user activity and behavior database 122.

A user interface server component 208 communicates with a user interface client component 210 located on a client device 212 to run the relevance model 202 and use its results to display or update the graphical user interface displayed to a user. This may be performed in response to a user input, such as a navigation input to a webpage that includes an area to display content items (such as a feed). For example, a user could instruct the user interface client component 210 to log into a social networking service account. This log-in information could then be sent to the user interface server component 208, which can use this information to instruct the ingestion platform 200 to retrieve the appropriate information from the profile database 118, the social graph database 120, the user activity and behavior database 122.

The results from the relevance model 202 could then be sent to the user interface server component 208, which, along with the user interface client component 210, could select and format appropriate content for display to the user.

In an example embodiment, the machine learning algorithm used to train the machine learning model may iterate among various weights (which are the parameters) that will be multiplied by various input variables (such as values in the body of the vent) and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the machine learning model may take place as a dedicated training phase. In other example embodiments, the machine learning model may be retrained dynamically at runtime by the user providing live feedback.

Another technical issue that is encountered is that a user intent or propensity to interact, or other types of user-related predictions, can vary over time. This can be phrased as varying over the course of a user “journey,” with the journey potentially lasting over the course of a long session, or even over multiple sessions. A user, for example, may not have a high propensity to click on a product description at the beginning of a journey, but may warm to the idea later in the journey. Current models lack the ability to forecast these varying timepoints in a user journey, and are limited to simply making a single prediction of a likelihood that a user will interact with a piece of content at some fixed time period. This is partly because current models rely on training data that utilizes interaction information (e.g., information about how past users interacted with previously presented content).

In an example embodiment, a more robust machine learning model is provided that is able to predict propensity to interact with content over multiple different time periods (e.g., at various time periods throughout a user journey). These different relevant time periods may be termed “phases” as to not imply that they are of fixed or consistent durations. The phases may include one or more phases in which the user is passive or mostly passive (e.g., not interacting as much with individual pieces of content and/or not proceeding to more advanced levels of interaction, such as purchasing a product or applying for a job), and one or more phases in which the user is active or mostly active (e.g., interacting more with individual pieces of content/proceeding to more advanced levels of interactions).

More particularly, in an example embodiment a phase determination machine learning model is trained to determine a phase of a user's journey for a given input user. This model may use features extracted from the user's interaction history, the type of content interacted with, and how the interactions occurred. For example, the model may note that a user interacted with content that is typically displayed during an initial phase of a user journey, which may lead the model to suspect that the user is still in the initial phase of the user journey. In another example the model may note that the user dwelled on a piece of content for a very long time, indicating that the user may be in a more advanced or later phase of the user journey.

In some example embodiments, the type of content the user interacted with can itself be fed into a GAI model to output an embedding reflecting an understanding of meaning of the content. This embedding may then be used as input to the phase determination machine learning model.

The output of the phase determination machine learning model is a predicted phase of a user journey for a particular input user. This phase determination can then be fed, along with other input features, to a separately trained content recommendation machine learning model. This separately trained content recommendation machine learning model may calculate a score for each of one or more pieces of content being considered for display to the user, and these pieces of content can then be ranked by those scores, with the ranking used to determine which pieces of content to display.

The prediction of propensity to interact with content over multiple phases is accomplished by measuring indirect signs of relevance, such as passive browsing (dwell time), lurking on content (post-click dwell) and passive disinterest signals (skip rates, measuring how often users skip over a piece of content, as measured by instances where a user interacts with a piece of content displayed before the piece of content at issue, as well as interacts with a piece of content displayed after the piece of content at issue). Additional signals can be created by creating in-line prompts around a piece of content where users can provide direct feedback.

Furthermore, the machine learning model may be trained to predict where each user is in their user journey by mapping behavioral signals into both a time dimension and a signal strength dimension.

It should also be noted that the input to the machine learning model that is used to predict where each user is in their user journey may include the embeddings described earlier, which can be generated using a GAI model. For example, the user profile of the user can be submitted to the GAI model, which can determine an embedding indicating generally the user's interests. The GAI model can also be used on the content itself, to determine the meaning of the content and allow the content recommendation machine learning model to recommend content appropriate for the user.

Table 1 below indicates users, dimensions, and types of signals of various different phases of different types of user's journeys, including early and late phases for each of passive and active users.

TABLE 1

| | | | | |
|---|---|---|---|---|
| Users . . . | . . . feel plugged into | . . . trust a set of | . . . want to actively | . . . want to validate if |
| | the trending | brands/products in | explore products | the product does |
| | products in their | their expertise | that can solve their | what they want it to |
| | industry | | problem | do before interaction |
| Dimensions | Strength: Implicit | Strength: Implicit | Strength: Implicit | Strength: Explicit |
| | Time: Long-term | Time: Long-term | Time: Recent, | Time: Recent, |
| | | | evergreen | recurring |
| Types of | Organic activity, | Pages/Products, | Topical/creator | User <> seller |
| signals | top-funnel content | newsletters, events | content, Project X, | activity, down-funnel |
| | | | search | content |

The user journey can also be expressed with the following categories:
1. (Passive User) Be in the know. “I am seeking knowledge about the overall industry landscape, trends, and products.”
2. (Passive User) Be an expert. “I feel like an expert on a set of technologies or trends.”
3. (Passive User) Brand/product favorability. “I trust a set of brands/products in their expertise.”
4. (Active User) Problem identification. “We need to do something.”
5. (Active User) Product exploration. “What's out there to solve our problem?”

6. (Active User) Requirements building. “What exactly do we need the purchase to do?”
7. (Active User) Product selection. “Does this do what we want it to do?”
8. (Active User) Validation. “We think we know the right answer, but we need to be sure.”
9. (Active User) Consensus creation. “We need to get everyone on board.”

Signals for the machine learning model may be obtained from various pieces of data related to a user. From these pieces of data, the machine learning model attempts to model various categories of aspects of the user that will be relevant in predicting propensity to interact at various phases in the user's journey. These categories can include user profile, user interest, user sentiment, and user intent. User profile includes an understanding of who the user is (e.g., work background, location, education, hobbies, etc.). User interest includes an understanding of the level of user interest in various topics (e.g., recent news, sports, business, etc.). User sentiment includes an understanding about how the user feels about various topics. User intent includes an understanding of whether there is likely to be an active action taken by a user.

The machine learning model can obtain signals from a variety of data sources to help model these various categories for each user. Such data sources include organic posts, organic conversations, content creator activities, search, user-to-user interactions, events, newsletters, topicality, product or company pages, ads, brand lift testing, groups, jobs, recruiter, courses, member profile, member context, and interaction with specific software products.

Signals from organic posts includes activities such as liking, sharing, comment on post content, as well as indirect measurements such as dwell time. Signals from organic conversations include text analysis of contribution content, and text analysis of expert content (page content, newsletters, creator posts, events, group contributions, etc.). Signals from content creator activities include creator followership and viewing activity on creator posts. Signals from search activities include search queries, the number of searches, and dwell time on search results.

Signals from user-to-user interactions include text analysis of the interactions (e.g., emails) as well as frequency information. Signals from events include registration activities in events. Signals from newsletters include newsletter subscriptions and newsletter article reading activities (clicks, visits, time spent, etc.). Signals from topicality include leveraged aggregate interest in topics, based on activity on out-of-network content. Signals from product or company pages include page followership, product page media activity, page followership derived from product page featured customers, and similar products viewing activity.

Signals from ads include user-ad interaction history, recent activity on ads, count of ad click, ad image content, ad text content, past click-through ratio performance, landing page content, where users clicked on an ad, ad dwell time, and dwell time after clicking on the landing page.

Signals from brand lift testing include lift in brand recall, lift in favorability, and lift in intent to purchase. Signals from groups include group joins/membership and group post activity.

Signals from jobs include job search queries and job applies. Signals from recruiters include various interaction with a software tool for recruiters, including types of job posted, recruiter login activity, and plan subscription. Signals from courses include clicks into learning courses and time spent on learning courses.

Signals from user profiles include demographic signals about the user, such as job, industry, company, etc. Signals from user context include device and time. Signals from interaction with specific software products include landing page visits, login activity, plan subscription, usage activity, and campaign count.

The result is that the system is able to identify a user's phase in their online journey, essentially classifying where the user is in a lifecycle of interactions with an online network. This can then be used as a signal input to a machine learning model that is trained to determine whether to show a particular piece of content to a user. For example, a user may not be interested in purchasing a product right now (i.e., “not in a buying mood”), but that may change later. By identifying that the user is in a phase of the lifecycle where purchasing a product is unlikely, the machine learning model is able to deduce, for example, that it may be more beneficial to delay displaying an ad for a product to the user until the user is in a different phase, even though mathematically there is still some value in displaying the ad now (e.g., there is a small chance the user may be persuaded to purchase the item now even though they are not in a buying mood).

It should be noted that while FIG. 2 depicts various components executing on an application server module, some of these components may, in some example embodiments, be located on a client device rather than an application server module 114, such as client device 212 of FIG. 2. For example, the GAI model 204 and/or the relevance model 202 may be located on the client device 212, while still performing the same or similar operations a when they are included in the application server module 114.

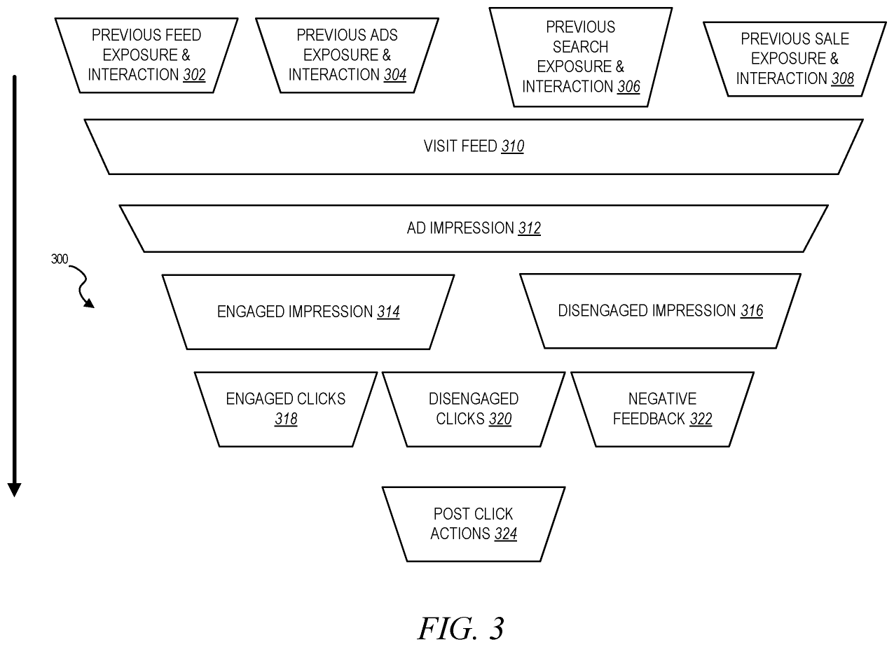

FIG. 3 is a diagram illustrating a buyer relevance journey map 300 in accordance with an example embodiment. Rather than considering the engagement between the user and a specific type of content, such as advertisements, the buyer relevance journey map 300 envisions understanding the user's phase in their journey indicating their intent based on a variety of different sources, including previous feed exposure and interaction 302, previous ads exposure and interaction 304, previous search exposure and interaction 306, previous sale exposure and interaction 308, user visits to the feed 310, actual ad impressions in response to user visits of the feed 312, engaged impressions 314 (including implied engagement via long dwell, video watch-through, etc.), disengaged impressions 316 (e.g. ad blindness), engaged clicks 318 (such as clicks on links and social interaction), disengaged clicks 320 (such as those with short dwell time), negative feedback (such as reports and hides) 322, and post-click actions 324 (such as lead generation or conversions).

Before the user comes to the feed, they may have previous product/company exposure and interaction through ads, organic posts, search or sale, either within the online network or from other sources. When they come to the online network, they may be served ads. They can choose to scroll down and ignore them (ads blindness) or stare at or click on the ads (engaged impression). After the engaged impression, they may move on to other feed posts, or choose to further engage with the ad by clicking it (e.g., expanding text, clicking on links, social reactions). In other cases they may also choose to hide or report the ads (negative feedback). Finally, users may sign up or make purchases, thus completing a journey.

Journey modelling may take multiple forms:

### In-Session User Journey Modelling

The modelling objectives can be decomposed based on the user and journey. Two examples are presented below.

### Impression->Engaged Impression->Click

“Engaged Impressions” may be defined as impressions where users truly view the ads instead of scrolling through. It can be derived by looking at the dwell time of users on the ads—if they spend enough time on the ads, it can be assumed that it is an engaged impression.

With engaged impression defined, the click-through-ratio (CTR) modeling can be decomposed as:

$$P ( click \vert impression ) = P ( click \vert engaged impression ) P ( engaged impression \vert impression ) + P ( click \vert non - engaged impression ) P ( non - engaged impression \vert impression )$$

### Impression->Engaged Click

“Engaged Clicks” may be defined as intentional clicks as opposed to clicking on ads by mistake. This can be approximated by the time users spend on an advertiser's website after clicking—if they exit within a second, it is not considered an engaged click.

With engaged click defined, CTR modeling can be decomposed as:

$$P ( click \vert impression ) = P ( engaged click \vert impression ) + P ( non - engaged click \vert impression )$$

### Long Term Buyer Journey Modelling

Certain users, such as business-to-business users, can build up their intention over months or even years. Their intention can become stronger through related ads, feed and other exposure on the online network or outside of the online network. And their user intention can be reflected by their ads activity or other activities such as searching and browsing for a product.

Combining ads activity sequence and cross-domain activity sequence, a user's interaction intent can be approximated more effectively. This may be accomplished using machine learning models such as a graph neural network (GNN) and sequence transformers. A GNN is a type of neural network that is designed to work with graphs, which are mathematical structures comprising nodes (also known as vertices) and edges that connect those nodes. The GNN operates by taking the graph as input and performing computations on it in order to learn patterns and relationships between the nodes and edges.

### Negative Sentiment Modelling

Negative ads feedback, such as “hide” or “report,” do not significantly affect monetization metrics, but are strong indicators of user experience. Incorporating negative sentiment modeling into the ranking objectives can be one step towards better user experience.

One challenge with negative sentiment would be the sparsity of negative feedback signals. In an example embodiment, crowdsourcing or using distillation methods are used to generate pseudo labels to handle this challenge.

### User-Oriented Ads Ranking

Typically for certain type of content, such as ads, Expected Clicks Per Impression (ECPI) is used as the objective function for a model that outputs a score indicative of a likelihood that a particular piece of content should be displayed to a user. In an example embodiment, however, a user experience score can be added on top of ECPI to adjust the final ranking. The “user experience score” can be a combination of true user intent and discounted by negative sentiments. For example,

$$UserScore = α p ( engagedImpression ) + β p ( engagedClick ) + γ p ( negativeFeedback )$$

While the straightforward way to add “user experience score” is

$$rankScore = ECPI + alpha * buyerScore$$

this will affect charging of advertisers and thus creates some technical challenges. If rankScore is treated as the new ECPI and advertisers are charged by it, then different types of ads will be affected differently by the UserScore.

Instead, the following alternative approaches could be used:

Approach 1: Incorporating user Score into Ranking Objective

Here, pCTR is adjusted in the following way:

$$rankScore = ECPI = pCTR . UserScoreAdjFactor . bid ( for click type ads ) \\ where \\ UserScoreAdjFactor = min ( upperBound , max ( lowerBound , \frac{UserScore}{refUserScore} ) ) \\ UserScore = f ( user , ad , context ) \\ refUserScore = f ( ad , context )$$

The UserScoreAdjFactor should average around 1.0 so that ECPI is not constantly increasing

Approach 2: Using user Score as a Filter Layer

Instead of changing the ranking objective function, filtering can be performed using the user score. For example, while in the past the top K ads are selected based on highest ECPI, this can be changed to pick the top K ads based on the highest user score instead. After returning those top K ads, the actual selection of which ads to display can be performed using ECPI.

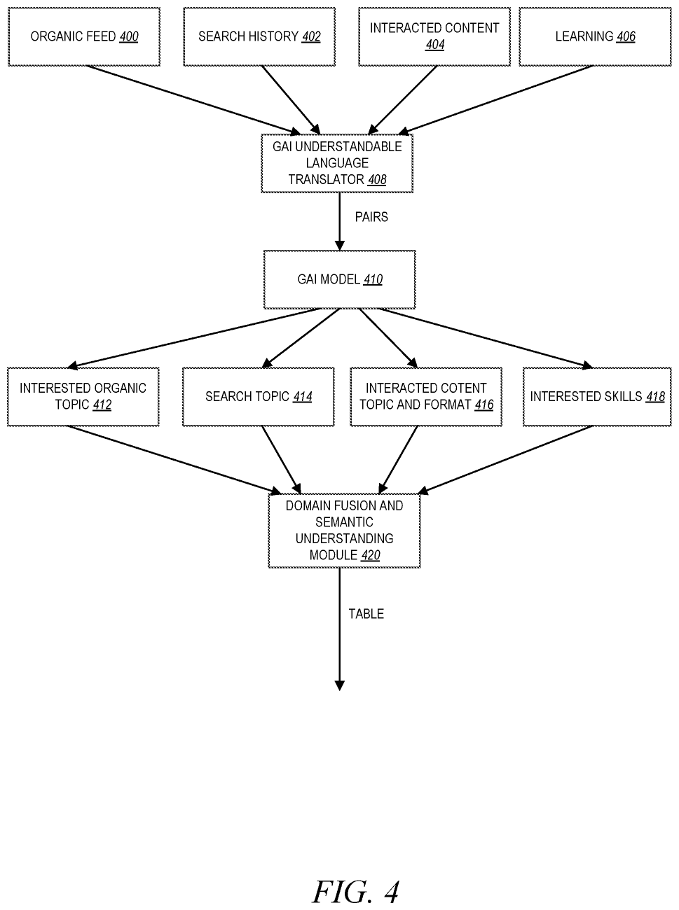

FIG. 4 is a block diagram illustrating an approach to understanding user experience generally, and not limited to one particular type of content, in accordance with an example embodiment. First, the user's footprint is collected across multiple domains: organic feed 400, search history 402, interacted content 404, and learning 406 (a portion of the online network dedicated to training and other learning materials and content). Table 2 below is an example of such a footprint. in table form:

TABLE 2

| Organic | Search | Ads | Learning |
|---|---|---|---|
| #Post Topic | # Job posted | # ML | # Course |
| Industry news and trend: NLP | Senior, MLE, Infra | Tools | Interested |
| Career development: mgr | # Senior People in | | |
| Company updates: XYZ | this area | | |
| # Duration, Click | # Search Frequency | | |

Then this footprint is converted to a language that a GAI model can give responses to. This may be called the GAI understandable language translator 408. The GAI understandable language translator 408 provides a sequence of <prompt, content> pairs. For example, for organic articles, the pair may be <summarize the text content in 10 key words, extracted organic article>, while for search history, the pair may be <summarize the industry member interested in, filtered search history which preserves privacy>. These pairs can all be sent to the GAI model 410 to obtain a set of topics the user is interested in across multiple domains. For example, here this would be a summarized interested organic topic 412, a search topic 414, an interacted content topic and format 416, and interested skills 418.

A domain fusion and semantic understanding module 420 can then fuse these topics to obtain a single data structure, such as a table, that includes the understanding of the user's interests.

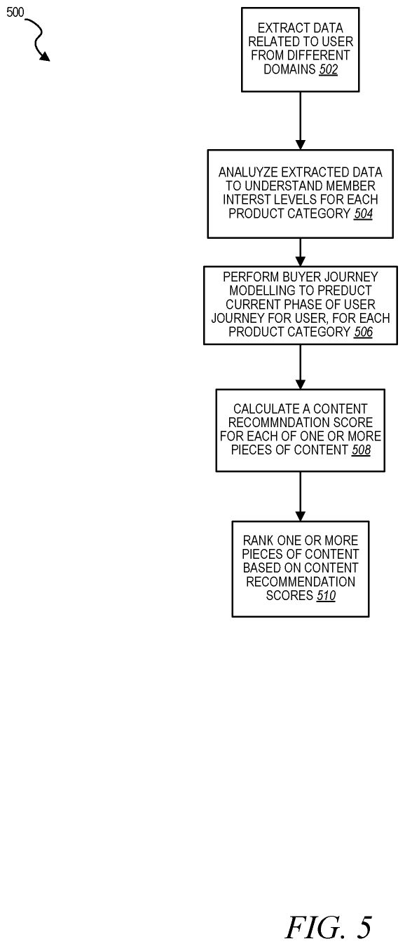

FIG. 5 is a flow diagram illustrating a method 500 of determining which pieces of content to display to a user, in accordance with an example embodiment. At operation 502, data regarding the user is extracted from multiple different domains. This data may include, for example, interaction data indicative of which pieces of content a user previously interacted with, how they interacted, and for how long they interacted. The different domains may be, for example, organic, search, advertisements, etc.

At operation 504, the extracted data is analyzed to develop an understanding of member interest levels for each product category based on behavior patterns across the domains. This analysis may include, for example, using a GAI model to develop an embedding score for various product categories. As an example, for member A, in the organic domain, the user may be assigned a medium interest level (engaged) for CRM, a deep interest level (very engaged) for SaaS, a low interest level (knowledge seeking) for manufacturing, and an expert interest level (creating content) for marketing technology. The same user may be assigned, in the jobs domain, a high interest level (very engaged) for CRM, a deep interest level (very engaged) for SaaS, a low interest level (knowledge seeking) for manufacturing, and a low interest level (knowledge seeking) for marketing technology.

At operation 506, buyer journey modelling is performed to predict a current phase of the user journey for the user, for each product category. Thus, for product category Z the user may be in a later stage (closer to purchasing) whereas for product category Y, the user may be in an early stage (knowledge seeking). This modelling may use the analysis performed at operation 504.

At operation 508, a content recommendation score is calculated, based on a separately trained machine learning model, for each of one or more pieces of content being considered for display to the user. This determination may be based on the output of operation 506.

At operation 510, one or more pieces of content being considered for display to the user are ranked based on their respective content recommendation score.

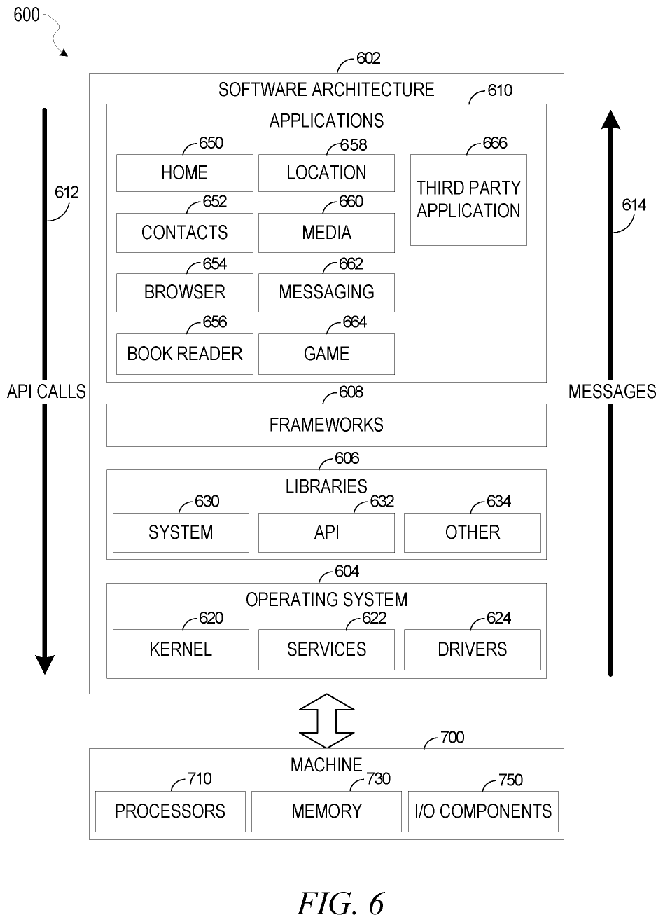

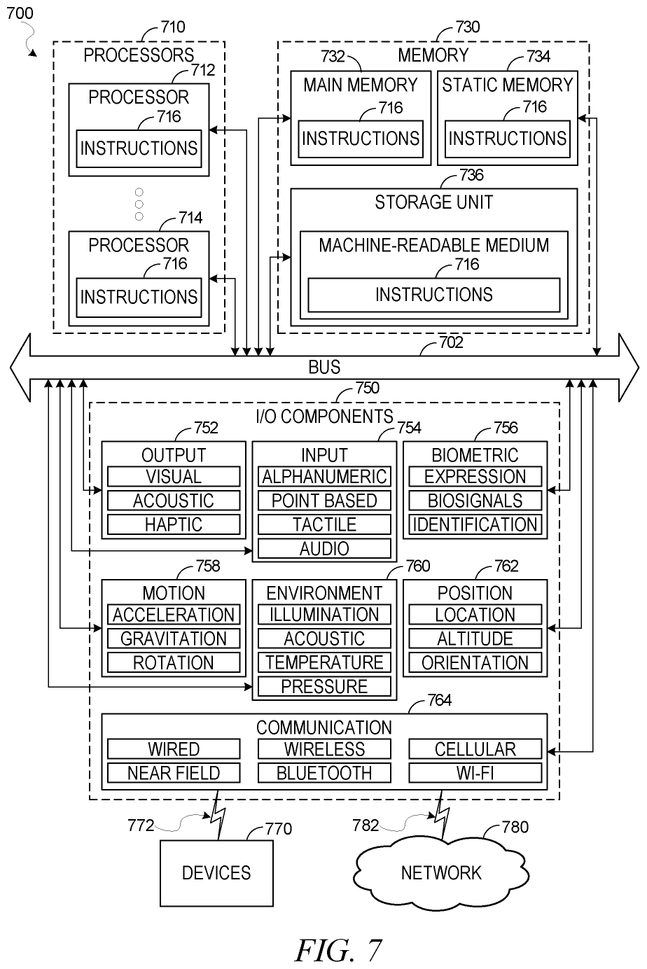

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphical user interface functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors 712 (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor), multiple processors 710 with a single core, multiple processors 710 with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one processor; and
at least one non-transitory computer-readable medium having instructions stored thereon, which, when executed by the at least one processor, cause the system to perform operations comprising:
accessing interaction data regarding one or more interactions between a user and digital content presented on one or more online platforms;
based on the interaction data and profile data associated with the user, predicting a journey phase of a user journey for the user, the journey phase indicative of user intent to perform a first type of interaction with a first online platform;
accessing a first piece of content presented on the first online platform;
feeding the first piece of content into a generative artificial intelligence (GAI) model, the GAI outputting an embedding corresponding to the first piece of content, the embedding being a representation of a meaning of the content;
feeding the journey phase and the embedding into a machine learning model trained separately from the GAI model, the machine learning model outputting a score for the first piece of content; and
determining whether to cause the first piece of content to be presented to the user via the first online platform based on the score.

2. The system of claim 1, wherein the machine learning model takes as input one or more features corresponding to the user in addition to the embedding.

3. The system of claim 2, wherein the one or more features corresponding to the user are extracted from a user profile.

4. The system of claim 1, wherein the operations further comprise recommending the first piece of content be displayed to the user based on a prediction of a likelihood that the user will interact with the first piece of content.

5. The system of claim 1, wherein the GAI model is further utilized to generate a textual description of why the first piece of content was recommended to the user.

6. The system of claim 5, wherein the feeding the first piece of content includes feeding the first piece of content and a list of categories into the GAI model, and the embedding represents a selection of a category from the list of categories, the category determined by the GAI model to be a closest match for the meaning of the content.

7. The system of claim 5, wherein the feeding the first piece of content includes additionally providing the GAI model with a text question about the first piece of content.

8. The system of claim 1, wherein the journey phase is predicted by mapping behavioral signals into a time dimension and a signal strength dimension.

9. The system of claim 1, wherein the interaction data includes data regarding interactions with a plurality of different content types.

10. A method comprising:
accessing interaction data regarding one or more interactions between a user and digital content presented on one or more online platforms;
based on the interaction data and profile data associated with the user, predicting a journey phase of a user journey for the user, the journey phase indicative of user intent to perform a first type of interaction with a first online platform;
accessing a first piece of content presented on the first online platform;
feeding the first piece of content into a generative artificial intelligence (GAI) model, the GAI outputting an embedding corresponding to the first piece of content, the embedding being a representation of a meaning of the content;
feeding the journey phase and the embedding into a machine learning model trained separately from the GAI model, the machine learning model outputting a score for the first piece of content; and
determining whether to cause the first piece of content to be presented to the user via the first online platform based on the score.

11. The method of claim 10, wherein the machine learning model takes as input one or more features corresponding to the user in addition to the embedding.

12. The method of claim 11, wherein the one or more features corresponding to the user are extracted from a user profile.

13. The method of claim 10, wherein the operations further comprise recommending the first piece of content be displayed to the user based on a prediction of a likelihood that the user will interact with the first piece of content.

14. The method of claim 10, wherein the GAI model is further utilized to generate a textual description of why the first piece of content was recommended to the user.

15. The method of claim 14, wherein the feeding the first piece of content includes feeding the first piece of content and a list of categories into the GAI model, and the embedding represents a selection of a category from the list of categories, the category determined by the GAI model to be a closest match for the meaning of the content.

16. The method of claim 14, wherein the feeding the first piece of content includes additionally providing the GAI model with a text question about the first piece of content.

17. The method of claim 14, wherein the GAI model is trained to understand content from different domains.

18. A non-transitory machine-readable storage medium comprising instructions which, when implemented by one or more machines, cause the one or more machines to perform operations comprising:
accessing interaction data regarding one or more interactions between a user and digital content presented on one or more online platforms;
based on the interaction data and profile data associated with the user, predicting a journey phase of a user journey for the user, the journey phase indicative of user intent to perform a first type of interaction with a first online platform;
accessing a first piece of content presented on the first online platform;
feeding the first piece of content into a generative artificial intelligence (GAI) model, the GAI outputting an embedding corresponding to the first piece of content, the embedding being a representation of a meaning of the content;
feeding the journey phase and the embedding into a machine learning model trained separately from the GAI model, the machine learning model outputting a score for the first piece of content; and
determining whether to cause the first piece of content to be presented to the user via the first online platform based on the score.

19. The non-transitory machine-readable storage medium of claim 18, wherein the machine learning model takes as input one or more features corresponding to the user in addition to the embedding.

20. The non-transitory machine-readable storage medium of claim 19, wherein the one or more features corresponding to the user are extracted from a user profile.
